(19) United States
(12) Patent Application Publication
(10) Pub. No.: US 2007/0197712 A1
(43) Pub. Date: Aug. 23, 2007

(54) Resin composition containing inorganic nucleating agent, molding thereof and process for producing the same

(75) Inventor: Kenichi Fujiwara, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IDEMITSU UNITECH CO., LTD., Tokyo (JP)

(21) Appl. No.: 10/592,479

(22) PCT Filed: Mar. 11, 2005
(86) PCT No.: PCT/JP05/04374

§ 371 Date: Jan. 18, 2007

(30) Foreign Application Priority Data
Mar. 11, 2004 (JP) 2004-068909

(51) Int. Cl. C08K 3/34

(52) U.S. Cl. 524/451; 524/505; 428/500

(57) ABSTRACT

The present invention provides a propylene resin composition (A) containing a combination of a component (a) a propylene homopolymer or propylene block copolymer having a propylene-chain isotactic pentad fraction of 0.90 or more; a component (b) an ethylene-α-olefin copolymer rubber, in an amount of 0.5 to 20 mass % when the component (a) is a propylene homopolymer, or in an amount of 0 to 10 mass % when the component (a) is a propylene block copolymer; a component (c) a high-density polyethylene, in an amount of 0 to 20 mass %; and a component (d) an inorganic nucleating agent, in an amount of 0.4 to 3.0 parts by mass on the basis of 100 parts by mass of the total amount of the components (a), (b), and (c), which composition exhibits high rigidity within a high-temperature range of room temperature or higher, which exhibits excellent impact resistance within a low-temperature range of the freezing point or lower, which emits odor at such a low level that it can be employed for food products, and which minimizes specific weight. The present invention also provides a multi-layer structure including at least one layer formed of the composition; a container produced through heat molding; an injection-molded product; an extrusion-molded product; and a method for producing such a molded product.

### TECHNICAL FIELD

The present invention relates to a resin composition containing an inorganic nucleating agent (hereinafter may be referred to as an “inorganic-nucleating-agent-containing resin composition”), which composition exhibits high elastic modulus within a high-temperature range of room temperature or higher, which exhibits excellent impact resistance within a low-temperature range of the freezing point or lower, which emits odor at such a low level that it can be employed for food products, and which minimizes increase in specific weight; to a multi-layer structure which includes at least one layer formed of the resin composition and which attains high percent reduction in weight; to a container produced through heat molding of the multi-layer structure; to an injection-molded product; to an extrusion-molded product; and to a method for producing such a molded product.

### BACKGROUND ART

There have been disclosed resin compositions which have somewhat similar in composition to the present invention; i.e., propylene resin compositions each containing an inorganic filler (e.g., talc) serving as a rigidity-improving material in combination with ethylene-α-olefin copolymer rubber (e.g., Patent Documents 1 to 4).

Although such propylene resin compositions exhibit somewhat improved balance between rigidity and impact resistance, the compositions have a drawback in terms of excessively high specific weight, and would raise a concern that the odor of the compositions exceeds an acceptable level.

As has been known, in automotive applications, there has been widely employed a reinforced polypropylene composite material containing impact-resistant block polypropylene (B-PP) serving as a base, ethylene-propylene rubber (EPR) in an amount of 20 to 30 mass %, and talc in an amount of 10 mass % or thereabouts (e.g., Non-Patent Document 1).

There have also been known, for example, a propylene polymer composition not containing talc and containing ethylene-butene rubber (EBR) and a nucleating agent, and a propylene polymer composition in which EBR is premixed with an nucleating agent or ethylene-α-olefin (C4 to C20) rubber (e.g., Patent Documents 5 to 7).

Although such a propylene polymer composition attains a certain level of improvement in rigidity, the composition poses an essential problem in terms of insufficient exhibition of impact resistance.

Talc has been known to serve as a crystal nucleating agent on a crystalline thermoplastic resin, but there have been few proposals for a polypropylene-based composition containing a small amount of talc.

For example, there has been proposed a polypropylene-based composition containing talc, which is added only for the purposes of reducing the post-shrinkage of a material formed of the composition (e.g., an automobile interior material) and of maintaining the transparency of such a material for securing interior visibility (e.g., Patent Document 8).

Addition of an a-crystal nucleating agent to highly stereoregular polypropylene is effective for improving the rigidity and impact resistance of the resultant polypropylene molded product (e.g., Patent Document 9), and incorporation of a mixture of a crystal nucleating agent and talc into block polypropylene (B-PP) is effective for improving the rigidity and low-temperature impact strength of B-PP (e.g., Patent Document 10).

In view of improvement of impact resistance, fluidity, and rigidity of polypropylene, and reduction of white fracture of polypropylene, there has been proposed a composition containing highly stereoregular polypropylene, an ethylene-α-olefin copolymer, and fine particulate talc.

As has been disclosed, the polypropylene composition has very high rigidity, fluidity, and impact resistance, can be readily processed, and exhibits little tendency to white fracture (e.g., Patent Document 11).

However, the aforementioned composition is not suitable for achieving the objects of the present invention, which are to maintain the impact resistance of a polypropylene composition at a certain level or more, to improve the elastic modulus of the composition, to reduce the thickness of a molded product, and to attain high percent reduction in weight of the molded product.

In view of improvement of impact resistance, transparency, resistance to heating for sterilization, etc., there has been proposed a specific composition containing polypropylene, an ethylene-α-olefin copolymer, an ethylene polymer, and a nucleating agent (e.g., Patent Document 12).

However, the ethylene-α-olefin copolymer employed in this composition has only a low density corresponding to that of linear low-density polyethylene.

Meanwhile, an ethylene-α-olefin copolymer employed in the resin composition of the present invention has a density corresponding to that of an elastomer, and thus the resin composition essentially differs from the aforementioned composition. Employment of a large amount of linear low-density polyethylene is not desirable for achieving the objects of the present invention, which are to maintain the low-temperature impact resistance of a resin composition, and to attain high percent reduction in weight of a molded product.

For the purpose of producing a polypropylene molded product having light weight and excellent rigidity, there has been proposed a specific composition containing highly stereoregular polypropylene, an ethylene-α-olefin copolymer elastomer, and a filler (e.g., Patent Document 13).

The amount of talc employed as a filler, which amount is disclosed in an embodiment of this composition, is 5 wt. % or 10 wt. %, which differs from the amount of talc employed in the present invention. In addition, the composition disclosed in this patent document, which employs talc as a filler, differs from the present invention in terms of technical concept.

The present invention employs a specific smaller amount of an inorganic substance (e.g., talc), and generally causes the substance to exhibit the effect of nucleating polypropylene crystals. The present invention employs such a substance in a small amount, and therefore can avoid disadvantages due to employment of the substance as a filler, including odor generation and poor appearance.

Containers for retort foods, etc. are required to have, for example, thermal resistance, rigidity, low-temperature impact resistance, little odor, and light weight.

In some cases, for example, a hermetically sealed container would dent under pressurized or reduced-pressure conditions, or may fail to endure impact during the course of distribution at a low temperature (the freezing point or lower).

In view that weight reduction of a container requires a decrease in thickness and an increase in rigidity, there has been invented a container containing an inorganic filler for attaining high rigidity (e.g., Patent Documents 14 to 18).

Incorporation of a large amount of an inorganic filler improves thermal resistance and. rigidity, but could cause problems in terms of, for example, an increase in specific weight and generation of abnormal odor. In general, such filler incorporation encounters difficulty in maintaining impact resistance within a low-temperature range.

In view that a container or the like is required to have thermal resistance and easy-to-open property, there has been invented a container in which easy peelability is imparted to a layer which seals a lid member (e.g., Patent Documents 19 to 23).

However, provision of a resin layer for imparting peelability (hereinafter such a layer may be referred to as a “peelability-imparting layer”) could impair thermal resistance or rigidity (e.g., Patent Documents 19 to 21).

In order to solve such a problem, employment of polyolefin of high thermal resistance has been proposed (e.g., Patent Documents 22 and 23). However, insufficient rigidity of a polypropylene resin layer could impair rigidity of the entirety of a container.

In order to enhance the rigidity of a polypropylene resin layer, generally, various attempts have been made; for example, molecular structure control (e.g., enhancement of the stereoregularity of polypropylene), high-order structure control (e.g., biaxial stretching), and incorporation of a crystal nucleating agent.

However, a limitation is imposed on the molecular structure control of polypropylene; high-order structure control (e.g., biaxial stretching) is difficult when carrying out general heat molding; and incorporation of an organic nucleating agent raises problems in that, for example, generation of odorous volatile components cannot be avoided.
Patent Document 1: Japanese Patent Application Laid-Open (kokai) No. H06-263960
Patent Document 2: Japanese Patent No. 2839840
Patent Document 3: Japanese Patent Application Laid-Open (kokai) No. H10-273569
Patent Document 4: Japanese Patent Application Laid-Open (kokai) No. 2003-183460
Patent Document 5: Japanese Patent No. 3115766
Patent Document 6: Japanese Patent Application Laid-Open (kokai) No. H11-1599
Patent Document 7: Japanese Patent Application Laid-Open (kokai) No. H11-209532
Patent Document 8: Japanese Patent Application Laid-Open (kokai) No. H06-287364
Patent Document 9: Japanese Patent Application Laid-Open (kokai) No. H09-194652
Patent Document 10: Japanese Patent No. 1782354
Patent Document 11: Japanese Patent Application Laid-Open (kokai) No. H10-120849
Patent Document 12: Japanese Patent No. 3506538
Patent Document 13: Japanese Patent No. 3472933
Patent Document 14: Japanese Patent Application Laid-Open (kokai) No. H11-293059
Patent Document 15: Japanese Patent Application Laid-Open (kokai) No. H11-240986
Patent Document 16: Japanese Patent Application Laid-Open (kokai) No. H11-29661
Patent Document 17: Japanese Patent Application Laid-Open (kokai) No. H08-156201
Patent Document 18: Japanese Patent Application Laid-Open (kokai) No. 2000-336218
Patent Document 19: Japanese Patent Publication (kokoku) No. H07-2409
Patent Document 20: Japanese Patent No. 2965825
Patent Document 21: Japanese Patent Application Laid-Open (kokai) No. H06-71824
Patent Document 22: Japanese Patent No. 3124206
Patent Document 23: Japanese Patent Application Laid-Open (kokai) No. H10-291561
Non-Patent Document 1: Nomura, et al., Kobunshi Ronbunshu, Vol. 50, No. 2, 81 (1993)

It has been found that, when an organic nucleating agent is employed in the present invention instead of an inorganic nucleating agent (e.g., talc), rigidity or elastic modulus reaches a certain level, but impact resistance is insufficiently exhibited; i.e., improvement of the balance between rigidity and impact resistance, which is an essential object of the present invention, is not necessarily attained.

It has also been found that a phosphorus-containing organic nucleating agent, which is generally considered to have low-level odor, generates a strong odor in the system of the present invention.

### DISCLOSURE OF THE INVENTION

The present invention contemplates provision of an inorganic-nucleating-agent-containing resin composition which exhibits high elastic modulus within a high-temperature range of room temperature or higher, which exhibits excellent impact resistance within a low-temperature range of the freezing point or lower, which emits odor at such a low level that it can be employed for food products, and which minimizes an increase in cost per volume which would otherwise be caused by specific weight increase; a multi-layer structure including at least one layer formed of the resin composition; a container produced through heat molding of the multi-layer structure; a molded product; and a method for producing such a molded product.

In other words, an object of the present invention is to reduce the weight of a molded product by providing a resin composition which does not raise problems in terms of, for example, odor generation, which maintains impact resistance at a certain level or more within a low-temperature range, and which exhibits improved elastic modulus within a high-temperature range of ambient temperature or higher.

The present inventor has found that a resin composition containing a combination of a propylene homopolymer or propylene block copolymer, an ethylene-a-olefin copolymer rubber, and an inorganic nucleating agent exhibits improved balance between rigidity and impact resistance, has low specific weight, emits low-level odor, and can solve the aforementioned problems. The present invention has been accomplished on the basis of this finding.

Accordingly, the present invention provides:
1. an inorganic-nucleating-agent-containing resin composition (A) characterized by comprising a combination of a component (a) a propylene homopolymer or propylene block copolymer having a propylene-chain isotactic pentad fraction of 0.90 or more; a component (b) an ethylene-α-olefin copolymer rubber, in an amount of 0.5 to 15 mass % when the component (a) is a propylene homopolymer, or in an amount of 0 to 10 mass % when the component (a) is a propylene block copolymer; a component (c) a high-density polyethylene, in an amount of 0 to 20 mass %; and a component (d) an inorganic nucleating agent, in an amount of 0.4 to 3.0 parts by mass on the basis of 100 parts by mass of the total amount of the components (a), (b), and (c);
2. an inorganic-nucleating-agent-containing resin composition (A) as described in 1 above, wherein the propylene homopolymer or propylene block copolymer has a propylene-chain isotactic pentad fraction of 0.95 or more;
3. an inorganic-nucleating-agent-containing resin composition (A) as described in 1 or 2 above, wherein, when the component (a) is a propylene homopolymer, the amount of the ethylene-α-olefin copolymer rubber is 0.5 to 10 mass %;
4. an inorganic-nucleating-agent-containing resin composition (A) as described in any of 1 to 3 above, wherein the ethylene-α-olefin copolymer rubber includes an α-olefin unit having 4 to 12 carbon atoms;
5. an inorganic-nucleating-agent-containing resin composition (A) as described in any of 1 to 4 above, wherein the ethylene-α-olefin copolymer rubber has a density of 840 to 900 kg/m³;
6. an inorganic-nucleating-agent-containing resin composition (A) as described in any of 1 to 5 above, wherein the high-density polyethylene has a density of 935 kg/m³ or more, and the amount of the high-density polyethylene is 1 to 20 mass %;
7. an inorganic-nucleating-agent-containing resin composition (A) as described in any of 1 to 6 above, wherein the inorganic nucleating agent is talc;
8. a multi-layer structure having a total thickness of 200 μm or more, characterized in that at least one layer constituting the multi-layer structure is formed of an inorganic-nucleating-agent-containing resin composition (A) as recited in any of 1 to 7 above, and the thickness of the resin composition layer accounts for 50% or more of the total thickness of the multi-layer structure;
9. a multi-layer structure having a total thickness of 200 μm or more, characterized in that at least one layer constituting the multi-layer structure is formed of an inorganic-nucleating-agent-containing resin composition (A) as recited in any of 1 to 7 above; the thickness of the resin composition layer accounts for 50% or more of the total thickness of the multi-layer structure; the multi-layer structure further comprises a surface layer formed of a propylene resin or propylene resin composition (B), and a peelability-imparting layer which is adjacent to the surface layer, which is formed of a resin composition or resin (C) containing a combination of a propylene resin in an amount of less than 80 mass % and a thermoplastic resin other than a propylene resin in an amount of 20 mass % or more, and which has a thickness 0.1 to 10% of the total thickness of the multi-layer structure; and a surface layer portion of the multi-layer structure, which portion includes the surface layer, has a peel strength of at least 1.0 to 10 N/10 mm width;
10. a container produced through heat molding of a multi-layer structure as recited in 8 or 9 above;
11. a container as described in 10 above, which is a food container;
12. an extrusion-molded product formed of an inorganic-nucleating-agent-containing resin composition (A) as recited in any of 1 to 7 above;
13. an injection-molded product formed of an inorganic-nucleating-agent-containing resin composition (A) as recited in any of 1 to 7 above;
14. a method for producing a molded product of an inorganic-nucleating-agent-containing resin composition (A) as recited in any of 1 to 7 above, comprising preparing a masterbatch containing a polyolefin resin as a base, and a component (d) at a high concentration; subsequently dry-blending the masterbatch with remaining components other than the component (d); and producing a molded product employing the dry-blended product as a raw material;
15. a method for producing a molded product as described in 14 above, wherein the molded product is a multi-layer structure;
16. a method for producing a molded product as described in 14 above, wherein the molded product is a container;
17. a method for producing a molded product as described in 14 above, wherein the molded product is an extrusion-molded product; and
18. a method for producing a molded product as described in 14 above, wherein the molded product is an injection-molded product.

The inorganic-nucleating-agent-containing resin composition of the present invention, which contains a combination of a propylene homopolymer or propylene block copolymer, an ethylene-α-olefin copolymer rubber, and an inorganic nucleating agent, exhibits excellent balance between rigidity and impact resistance, has low specific weight, generates no odor, and is inexpensive.

The composition of the present invention does not raise problems in terms of, for example, odor generation, maintains impact resistance at a certain level or more within a low-temperature range, and exhibits improved elastic modulus within a high-temperature range of ambient temperature or higher, and thus employment of the composition attains weight reduction of a molded product (i.e., final product). Therefore, the cost required for production of the molded product can be reduced, and the volume of the molded product can be reduced when it is disposed of after completion of its predetermined role.

### BRIEF DESCRIPTION OF THE DRAWINGS

FIG. 1 is a cross-sectional view showing an embodiment of the multi-layer structure of the present invention.

FIG. 2(a) is a top view showing an exemplary container formed of the multi-layer structure of the present invention; and FIG. 2(b) is a cross-sectional view of the container.

FIG. 3 schematically shows S values and the relation between −5° C. falling dart impact strength (Y-axis) and 80° C. elastic modulus (X-axis).

FIG. 4 shows the effect of contained talc (mean particle size: 4.9 μm) on the percent reduction in weight of a molded product (see Examples 13 to 15 and Comparative Examples 18 to 20 in Table 5).

FIG. 5 shows the effect of contained talc (mean particle size: 1.0 μm) on the percent reduction in weight of a molded product (see Examples 27 to 29 and Comparative Examples 24 to 26 in Table 6).

### DESCRIPTION OF REFERENCE NUMERALS

10: Multi-layer structure
1: Oxygen gas barrier layer
2a, 2b: Adhesive resin layer
3a, 3b: Inorganic-nucleating-agent-containing resin composition layer
4: Peelability-imparting layer
5: Surface layer
(a): Top view
(b): Cross-sectional view

### BEST MODE FOR CARRYING OUT THE INVENTION

The inorganic-nucleating-agent-containing resin composition (A) of the present invention contains, as a component (a), a propylene homopolymer or propylene block copolymer having a propylene-chain isotactic pentad fraction of 0.90 or more.

Examples of the propylene block copolymer include a propylene block copolymer having a homopolymer segment formed of a propylene homopolymer and a copolymer segment formed of an ethylene-propylene random copolymer containing a relatively large number of ethylene units; and a crystalline propylene-ethylene-α-olefin copolymer formed through copolymerization, with an α-olefin (e.g., butene-1), of the homopolymer segment or copolymer segment of the aforementioned propylene block copolymer.

In the present invention, the aforementioned propylene block copolymer or propylene homopolymer preferably has an isotactic pentad fraction of 0.95 or more, for attaining improved properties such as rigidity and thermal resistance.

As used herein, the term “isotactic pentad fraction” refers to a fraction of isotactic pentad chain segments in a propylene polymer molecule chain as measured through the method disclosed in Macromolecules, 6, 925 (1973) by A. Zambelli, et al.; i.e., the method employing ¹³C-NMR. In other words, “isotactic pentad fraction” is a fraction of propylene monomer units forming a chain segment in which five continuous propylene monomer units are meso-bonded together.

NMR absorption peaks are assigned on the basis of the relevant description in Macromolecules, 8, 687 (1975).

Specifically, isotactic pentad fraction is determined as an area fraction of mmmm peaks in all the absorption peaks in the methyl carbon region of a ¹³C-NMR spectrum.

Specifically, in order to obtain the isotactic pentad fraction of a propylene homopolymer, the homopolymer is subjected to ¹³C-NMR measurement as it is. Meanwhile, in order to obtain the isotactic pentad fraction of a propylene block copolymer, the copolymer is dissolved in heated xylene, and then insoluble components obtained after cooling to ambient temperature are subjected to ¹³C-NMR measurement.

Such a highly stereoregular propylene homopolymer or propylene block copolymer can be produced by use of, for example, a Ziegler-Natta catalyst.

There can be employed a polymer having a melt flow rate (MFR) (temperature: 230° C., load: 21.2 N) of 0.01 to 100 g/10 minutes, preferably 0.1 to 50 g/10 minutes.

The inorganic-nucleating-agent-containing resin composition (A) of the present invention may contain, as a component (b), an ethylene-α-olefin copolymer rubber formed through random copolymerization of ethylene with a C3-C20 α-olefin or with a C3-C20 α-olefin and a diene monomer.

Examples of the C3-C20 α-olefin include propylene, butene-1, hexene-1, octene-1, nonene-1, decene-1, undecene-1, and dodecene-1.

Preferably, a C4-C12 α-olefin is employed.

Examples of the diene monomer include conjugated diene compounds such as butadiene and isoprene; and nonconjugated diene compounds such as 1,4-hexadiene, 1,6-octadiene, cyclopentadiene, 5-ethylidene-2-norbornene, and 5-isopropylidene-2-norbornene.

Examples of the ethylene-α-olefin copolymer rubber include ethylene-propylene copolymer rubber (EPR), ethylene-propylene-diene copolymer rubber (EPDM), ethylene-butene-1 copolymer rubber (EBR), ethylene-hexene-1 copolymer rubber, ethylene-octene-1 copolymer rubber (EOR), ethylene-decene-1 copolymer rubber, and ethylene-dodecene-1 copolymer rubber.

Any of these ethylene-α-olefin copolymer rubbers is a thermoplastic elastomer.

These ethylene-α-olefin copolymer rubbers may be employed singly or in combination of two or more species.

The inorganic-nucleating-agent-containing resin composition (A) of the present invention contains, as a component (d), an inorganic nucleating agent, which drastically increases the rate of crystal nucleation during the course of polypropylene crystallization. Examples of the inorganic nucleating agent include talc, mica, carbon black, silica, dolomite powder, silicate, quartz powder, diatomaceous earth, and alumina.

These inorganic nucleating agents may be employed singly or in combination of two or more species.

From the viewpoint of promotion of polypropylene crystallization, fine particulate talc is particularly preferred.

An inorganic nucleating agent to be employed may be directly dry-blended with a resin material. However, from the viewpoint of enhancement of dispersibility of the inorganic nucleating agent in the resin composition, preferably, there is employed a masterbatch which has been prepared in advance by incorporating a large amount of the inorganic nucleating agent into a resin (e.g., polypropylene).

Examples of the masterbatch which may be employed include, but are not limited to, a masterbatch containing the inorganic nucleating agent in an amount of 5 to 80 mass %.

No particular limitation is imposed on the method for preparing such a masterbatch, and the masterbatch may be prepared through a known method; for example, a continuous method employing a uniaxial or biaxial kneader/extruder, a batch-type method employing a Banbury mixer, a Henschel mixer, or a similar mixer, or a method employing gelation.

In order to secure high dispersibility of the inorganic nucleating agent in the resin composition, preferably, the nucleating agent is sufficiently dispersed in the thus-prepared masterbatch.

The inorganic nucleating agent to be employed may be subjected to no treatment. However, for the purpose of improving interfacial adhesiveness or dispersibility, the inorganic nucleating agent may be subjected to surface treatment with a generally known silane coupling agent, titanium coupling agent, or surfactant (e.g., a higher fatty acid, a higher fatty acid ester, a higher fatty acid amide, or a higher fatty acid salt).

No particular limitation is imposed on the particle size of the inorganic nucleating agent. However, the smaller the particle size of the nucleating agent, the greater the effects of the nucleating agent.

The talc to be employed is in the form of fine powder generally having a mean particle size of 15 μm or less, preferably 7 μm or less.

The minimum particle size of currently commercially available talc is 1 μm.

From the viewpoint of the balance between rigidity and impact resistance, the talc to be employed preferably has a smaller mean particle size, so long as the talc can be uniformly dispersed in a masterbatch to be prepared and in a molded product (i.e., a final product).

Talc is inorganic powder prepared through pulverization of talcum, and contains hydrated magnesium silicate [Mg₃Si₄O₁₀(OH) ₂] as a primary component.

As used herein, the term “mean particle size” refers to 50%-equivalent particle size (D₅₀) determined from the distribution curve of particle sizes as measured through laser diffractometry, which particle size is generally about 2 to about 5 times the value determined through the precipitation method (i.e., 50%-equivalent particle size (D50) determined from an integral distribution curve through the sieving method, in which the particle size of talc suspended in a dispersion medium (e.g., water or alcohol) is measured by means of a centrifugal sedimentation-type particle size distribution measuring apparatus).

Talc having a mean particle size falling within the above range can be uniformly dispersed in the inorganic-nucleating-agent-containing resin composition (A) . Thus, even when a small amount of such talc is incorporated into the resin composition, the talc can sufficiently serve as a nucleating agent. Therefore, the rigidity of the resin composition is enhanced, and. the thickness of the composition can be reduced. In addition, since the talc is uniformly dispersed in the resin composition, a decrease in impact resistance is suppressed.

The inorganic-nucleating-agent-containing resin composition (A) of the present invention has two modes. A first mode is a composition containing a combination of any of the aforementioned propylene block copolymers (component (a)) in an amount of 100 to 70 mass %; an ethylene-α-olefin copolymer rubber (component (b)) in an amount of 0 to 10 mass %; a high-density polyethylene (component (c)) in an amount of 0 to 20 mass %; and an inorganic nucleating agent in an amount of 0.4 to 3.0 parts by mass on the basis of 100 parts by mass of the total amount of the aforementioned components (a), (b), and (c).

When the amount of the inorganic nucleating agent falls outside the above range, weight reduction, which is an object of the present invention, fails to be attained sufficiently.

When the amount of the ethylene-α-olefin copolymer rubber is below the above range, sufficient impact resistance fails to be attained, whereas when the amount exceeds the above range, elastic modulus is lowered, and improvement of percent reduction in thickness and weight of a molded product, which is an object of the present invention, fails to be attained sufficiently.

When the amounts of the aforementioned four components fall within the above respective ranges, the composition exhibits excellent thermal resistance, rigidity, impact resistance, etc., and is less likely to raise problems (e.g., an increase in specific weight, and generation of abnormal odor).

In the aforementioned four-component combination, preferably, the amounts of the respective components are as follows: the propylene block copolymer: 99 to 75 mass %; the ethylene-α-olefin copolymer rubber: 0 to 5 mass %; the high-density polyethylene: 1 to 20 mass %; and the inorganic nucleating agent: 0.4 to 3.0 parts by mass on the basis of 100 parts by mass of the total amount of these resin components. More preferably, the amounts of the respective components are as follows: the propylene block copolymer: 95 to 82 mass %; the ethylene-a-olefin copolymer rubber: 0 to 3 mass %; the high-density polyethylene: 5 to 15 mass %; and the inorganic nucleating agent: 0.4 to 3.0 parts by mass on the basis of 100 parts by mass of the total amount of these resin components.

The density of the ethylene-α-olefin copolymer rubber is 840 to 900 kg/m³, preferably 850 to 890 kg/m³.

When the density is below the above range, thermal resistance is impaired, whereas when the density exceeds the above range, impact resistance fails to be attained sufficiently.

The density of the high-density polyethylene is 935 kg/m³ or more, preferably 945 kg/m³ or more.

When the density falls within the above range, thermal resistance is not impaired, and the balance between rigidity and impact resistance is improved.

When the density of the high-density polyethylene is below the above range, elastic modulus is lowered, and improvement of percent reduction in thickness and weight of a molded product, which is an object of the present invention, fails to be attained sufficiently.

A second mode is a composition containing a combination of any of the aforementioned propylene homopolymers (component (a)) in an amount of 99.5 to 65 mass %; an ethylene-α-olefin copolymer rubber (component (b)) in an amount of 0.5 to 15 mass %; a high-density polyethylene (component (c)) in an amount of 0 to 20 mass %; and an inorganic nucleating agent (component (d)) in an amount of 0.4 to 3.0 parts by mass on the basis of 100 parts by mass of the total amount of the aforementioned components (a), (b), and (c).

When the amount of the inorganic nucleating agent falls outside the above range, weight reduction, which is an object of the present invention, fails to be attained sufficiently.

When the amount of the ethylene-α-olefin copolymer rubber is below the above range, sufficient impact resistance fails to be attained, whereas when the amount exceeds the above range, elastic modulus is lowered, and improvement of percent reduction in thickness and weight of a molded product, which is an object of the present invention, fails to be attained sufficiently (see Table 5).

When the amounts of the aforementioned four components fall within the above respective ranges, the composition exhibits excellent thermal resistance, rigidity, impact resistance, etc., and is less likely to raise problems (e.g., an increase in specific weight, and generation of abnormal odor).

In the aforementioned four-component combination, preferably, the amounts of the respective components are as follows: the propylene homopolymer: 98 to 68 mass %; the ethylene-a-olefin copolymer rubber: 1 to 12 mass %; the high-density polyethylene: 1 to 20 mass %; and the inorganic nucleating agent: 0.4 to 3.0 parts by mass on the basis of 100 parts by mass of the total amount of these resin components. More preferably, the amounts of the respective components are as follows: the propylene homopolymer: 93 to 75 mass %; the ethylene-α-olefin copolymer rubber: 2 to 10 mass %; the high-density polyethylene: 5 to 15 mass %; and the inorganic nucleating agent: 0.4 to 3.0 parts by mass on the basis of 100 parts by mass of the total amount of these resin components.

The density of the ethylene-a-olefin copolymer rubber is 840 to 900 kg/m³, preferably 850 to 890 kg/m³.

When the density is below the above range, thermal resistance is impaired, whereas when the density exceeds the above range, impact resistance fails to be attained sufficiently.

The density of the high-density polyethylene is 935 kg/m³ or more, preferably 945 kg/m³ or more.

When the density falls within the above range, thermal resistance is not impaired, and the balance between rigidity and impact resistance is improved.

When the density of the high-density polyethylene is below the above range, elastic modulus is lowered, and improvement of percent reduction in thickness and weight of a molded product, which is an object of the present invention, fails to be attained sufficiently.

In the method for producing the inorganic-nucleating-agent-containing resin composition (A) of the present invention, all the aforementioned components may be mixed/kneaded together at a time.

Alternatively, the composition of a molded product may be caused to be the same as that of the resin composition (A) of the present invention through the following procedure: a masterbatch containing a polyolefin (e.g., polypropylene or polyethylene) serving as a base and an inorganic nucleating agent (e.g., talc) is prepared in advance such that the inorganic nucleating agent content is higher than that of the resin composition (A) of the present invention; a predetermined amount of the thus-prepared masterbatch is dry-blended with the other components; and the resultant blend (i.e., raw material) is fed to a hopper of a molding machine, followed by extrusion molding.

In the aforementioned two modes of the inorganic-nucleating-agent-containing resin composition (A) of the present invention, the amount of fine talc powder serving as an inorganic nucleating agent may be reduced to a relatively low level, so long as the mean particle size of the fine talc powder is as small as 15 μm or less, and the powder exhibits good dispersibility. Therefore, while an increase in specific weight is suppressed, rigidity, etc. can be improved without causing deterioration of impact resistance.

When the amount of talc contained in the resin composition falls within the above-described range, generation of abnormal odor is suppressed.

Meanwhile, when an organic nucleating agent such as a sorbitol derivative (e.g., dibenzylidene sorbitol or dimethylbenzylidene sorbitol) or an organic phosphate (e.g., sodium 2,2-methylenebis(4,6-di-t-butylphenyl) phosphate) is employed, elastic modulus (rigidity) is improved at a certain level, but, as shown in the below-described Comparative Examples, incorporation of a small amount (0.1 to 0.3 mass %) of such an organic nucleating agent could cause generation of abnormal odor or considerable deterioration of impact resistance.

If necessary, the composition of the present invention may further contain the following resin, for the purpose of improving, for example, the balance between physical properties:
(1) a polyethylene resin such as low-density polyethylene formed by use of a Ziegler-Natta catalyst, a metallocene catalyst, or a similar catalyst, or polyethylene or ethylene copolymer formed through the high-pressure method;
(2) a hydrogenated butadiene copolymer rubber such as styrene-butadiene rubber (SBR) or a hydrogenated product thereof (SEBS), styrene-ethylene/butylene-olefin crystal block polymer, or olefin crystal-ethylene/butylene-olefin crystal block polymer; or
(3) another thermoplastic resin.

The inorganic-nucleating-agent-containing resin composition (A) of the present invention may be formed into pellets by subjecting a dry blend containing predetermined components in predetermined proportions to a melt-mixing process employing a uniaxial extruder, a biaxial extruder, a Banbury mixer, a Henschel mixer, or a similar apparatus. Alternatively, the resin composition (A) may be formed into a variety of molded products by subjecting such a dry blend to plasticization, melting, and mixing steps in a melt-molding process (e.g., extrusion molding, injection molding, or blow molding), which is generally applied to a thermoplastic resin.

In such a melt-molding process, if necessary, a generally employed additive (e.g., an antioxidant, a lubricant, or an antistatic agent) may be added to the inorganic-nucleating-agent-containing resin composition (A) of the present invention.

Any coloring agent may also be added to the resin composition.

In an extrusion process, pellets and irregularly shaped extruded products can be produced. In addition, a variety of extrusion-molded products (e.g., single-layer or multi-layer film products, and sheet-like products) can be produced by means of a T-die, a circular die, or a similar die.

In the case where the inorganic-nucleating-agent-containing resin composition (A) of the present invention is subjected to extrusion molding, there is preferably employed, as a component (a), a propylene homopolymer or propylene block copolymer having a melt flow rate (MFR) (temperature: 230° C., load: 21.2 N) of 0.01 to 20 g/10 minutes, more preferably 0.1 to 5 g/10 minutes.

When a propylene polymer having an MFR falling within the above range is employed, high elastic modulus and low-temperature impact resistance can be maintained, and reliable molding can be performed.

A polypropylene having a melt flow rate [MFR (temperature: 230° C., load: 21.2 N)] of 3 to 100 g/10 minutes (preferably about 5 to about 50 g/10 minutes) is suitable for the production of a molded product of small thickness through injection molding. When such a polypropylene is employed, higher elastic modulus is attained, and thickness reduction is facilitated, and thus higher percent reduction in weight can be attained.

There is preferably employed, as a component (b), an ethylene-α-olefin copolymer rubber having an MFR (temperature: 190° C., load: 21.2 N) of 0.01 to 20 g/10 minutes, more preferably 0.1 to 10 g/10 minutes.

When an ethylene-α-olefin copolymer rubber having an MFR falling within the above range is employed, the copolymer rubber is uniformly dispersed in the inorganic-nucleating-agent-containing resin composition (A), and thus the resultant composition and molded product exhibit excellent moldability and impact resistance.

The multi-layer structure of the present invention includes at least one layer formed of the aforementioned inorganic-nucleating-agent-containing resin composition (A), and the thickness of the layer formed of the inorganic-nucleating-agent-containing resin composition (A) accounts for 50% or more of the total thickness of the multi-layer structure.

The multi-layer structure, which exhibits easy peelability, may further include a surface layer formed of a propylene resin or propylene resin composition (B), and a layer which is adjacent to the surface layer, which is formed of a resin composition or resin (C) containing a combination of a propylene resin in an amount of less than 80 mass % and a thermoplastic resin other than a propylene resin in an amount of 20 mass % or more, and which has a thickness 0.1 to 10% of the total thickness of the multi-layer structure, wherein a surface layer portion of the multi-layer structure, which portion includes the surface layer, has a peel strength of 1.0 to 10 N/10 mm width.

The layer formed of the resin composition or resin (C) serves as a layer for imparting peelability to the surface layer portion.

Peeling of the surface layer portion may be attributed to cohesive failure of the upper or lower interface of the layer formed of the resin composition or resin (C), or cohesive failure of the resin material per se constituting the layer.

The propylene resin constituting the aforementioned propylene resin or propylene resin composition (B) may be, for example, the above-described propylene homopolymer or propylene block copolymer employed in the inorganic-nucleating-agent-containing resin composition (A), or a random copolymer of propylene and an a-olefin other than propylene. Specific examples of the random copolymer include propylene-ethylene random copolymers, propylene-butene-1 random copolymers, and propylene-ethylene-butene-1 random copolymers.

These propylene polymers may be employed singly or in combination of two or more species.

The surface layer may be formed of a composition containing a propylene resin and a thermoplastic resin (e.g., an olefin resin other than a propylene resin).

When the surface layer is formed of a propylene resin or a propylene resin composition, the layer can maintain thermal resistance at a certain level.

When the surface layer is formed of, for example, polyethylene, a limitation is imposed on the thermal resistance of the layer.

The propylene polymer constituting the resin composition or resin (C), which exhibits peelability, may be any of the propylene resins exemplified above in description of the resin or resin composition (B).

These propylene resins may be employed singly or in combination of two or more species.

Examples of thermoplastic resins other than the aforementioned propylene polymers include homopolymers of α-olefins (e.g., ethylene, butene-1,3-methylbutene-1,3-methylpentene-1, and 4-methylpentene-1), homopolymers of cyclic olefins (e.g., norbornene), and copolymers of these homopolymers.

Typical examples include high-density polyethylene, middle-density polyethylene, low-density polyethylene, linear low-density polyethylene, ultra high molecular weight polyethylene, ethylene-vinyl acetate copolymer, ethylene-ethyl acrylate copolymer, ethylene-norbornene copolymer, ethylene-tetracyclododecene copolymer, polybutene-1, and poly(4-methylpentene-1).

These thermoplastic resins may be employed singly or in combination of two or more species.

When the resin composition or resin (C), which exhibits peelability, contains a combination of a propylene polymer (less than 80 mass %) and a thermoplastic resin other than a propylene polymer (20 mass % or more), the surface layer portion exhibits sufficient peelability by means of interfacial failure, or cohesive failure of the composition or resin per se.

In the aforementioned combination, preferably, the amount of a propylene polymer is 0 to 75 mass %, and the amount of a thermoplastic resin other than a propylene polymer is 25 to 100 mass %.

The multi-layer structure of the present invention has a thickness (total thickness) of 200 μm or more, preferably 400 to 2,000 μm.

The thickness of the layer formed of the aforementioned inorganic-nucleating-agent-containing resin composition (A) accounts for 50% (100 μm) or more (preferably 70% or more) of the total thickness of the multi-layer structure.

When the thickness of the resin composition layer accounts for 50% or more of the total thickness, the multi-layer structure can maintain mechanical properties (e.g., thermal resistance, rigidity, and impact resistance) at a certain level or more.

The thickness of the aforementioned peelability-imparting layer accounts for about 0.1 to about 10% (preferably 0.3 to 7%) of the total thickness of the multi-layer structure.

When the thickness of the peelability-imparting layer accounts for 0.1% or more of the total thickness, the thickness of the layer can be reliably uniformized, whereas when the layer thickness accounts for 10% or less of the total thickness, even if the thermal resistance or rigidity of a thermoplastic resin (other than a propylene polymer) employed in the peelability-imparting layer is inferior to that of a propylene resin, the entirety of the multi-layer structure can maintain mechanical properties at a certain level.

The multi-layer structure has a peel strength of about 1.0 to about 10 N/10 mm width, preferably 1.5 to 5 N/10 mm width.

As used herein, the term “peel strength” refers to the peel strength of the surface layer portion; i.e., the cohesive failure strength of the peelability-imparting layer per se, or the interfacial failure strength between the peelability-imparting layer and a layer adjacent thereto.

In the case where the peel strength is 10 N/10 mm width or less, when the surface layer is melt-adhered to a lid member through heat-sealing or a similar technique, an appropriate resistance is generated upon peeling of the lid member from the surface layer. Meanwhile, when the peel strength is 1.0 N10 mm width or more, similar to the case described above, an appropriate resistance is generated, and thus no peeling of the lid member occurs due to, for example, impact generated during the course of physical distribution, etc., before artificial or intentional peeling of the lid member; i.e., the multi-layer structure is satisfactory for practical use.

The multi-layer structure of the present invention may further include an additional material layer, for the purposes of improving oxygen gas barrier property and suppressing deformation.

Examples of the additional material layer include layers formed of resins (e.g., ethylene-vinyl alcohol copolymer (EVOH), polyvinylidene chloride (PVDC), nylon, and polyethylene terephthalate), an aluminum deposition layer, and layers formed of materials having excellent gas barrier property (e.g., aluminum foil, aluminum, iron, and copper).

EVOH having an ethylene unit content of 20 to 60 mol % is preferably employed.

EVOH to be employed preferably contains one or more antioxidant substances selected from among vitamin E, vitamin C, flavonoid, and carotenoid in an amount of 0.1 to 5,000 mass ppm on the basis of the entirety of the resin.

Incorporation of such an antioxidant substance can further reduce the odor level of the multi-layer structure or a container formed therefrom.

PVDC to be employed is preferably a vinylidene chloride-vinyl chloride copolymer or a vinylidene chloride-methacrylic acid copolymer.

The additional material layer may be formed of a single layer or two or more layers.

The additional material layer may be formed of a composite material containing resin, and metal, paper, etc.

The surface layer of the multi-layer structure of the present invention, which serves as a sealing portion when the structure is formed into a container, may be formed of a propylene resin (e.g., homopolypropylene, propylene-ethylene random copolymer, propylene-ethylene-butene random copolymer, or propylene-ethylene block copolymer) or a resin composition containing such a resin as a base.

The multi-layer structure of the present invention can be formed by subjecting, to extrusion molding, lamination, or combination of these techniques, the aforementioned inorganic-nucleating-agent-containing resin composition (A), the propylene resin or propylene resin composition (B), the resin composition or resin (C), and an additional material (e.g., a material for improving oxygen gas barrier property).

If necessary, each of the inorganic-nucleating-agent-containing-resin composition (A), the propylene resin or propylene resin composition (B), and the resin composition or resin (C) may appropriately contain an additive such as an antioxidant, a UV-absorbing agent, a lubricant, a pigment, an antistatic agent, a copper inhibitor, a fire retardant, a neutralizing agent, a foaming agent, a plasticizer, a nucleating agent, an antifoaming agent, or a cross-linking agent, so long as the objects of the present invention are not impeded.

The multi-layer structure of the present invention may be in the form of a coextruded multi-layer molded product formed by coextruding, through a multi-layer die, the materials for the layers constituting the structure by means of, for example, a plurality of extruders.

In the case where a layer formed of EVOH or another material is provided for the purpose of, for example, improving oxygen gas barrier property, in order to enhance adhesion between the oxygen-gas-barrier-property-improving layer and a layer adjacent thereto, if desired, an adhesive resin layer may be provided between these layers.

Examples of the material for the adhesive resin layer include maleic-anhydride-modified polypropylene or polyethylene; ethylene-(meth)acrylate copolymers such as ethylene-methyl (meth)acrylate copolymer and ethylene-ethyl (meth)acrylate copolymer; ethylene-vinyl acetate copolymer; and ethylene-styrene copolymer.

When the multi-layer structure of the present invention is formed through lamination, any lamination technique such as extrusion lamination, hot melt lamination, dry lamination, or wet lamination can be employed.

The thus-coextruded multi-layer sheet may be recycled to provide the layer formed of the inorganic-nucleating-agent-containing resin composition (A).

In such a case, preferably, one or more antioxidant substances selected from among vitamin E, vitamin C, flavonoid, and carotenoid are added in an amount of 0.1 to 5,000 mass ppm.

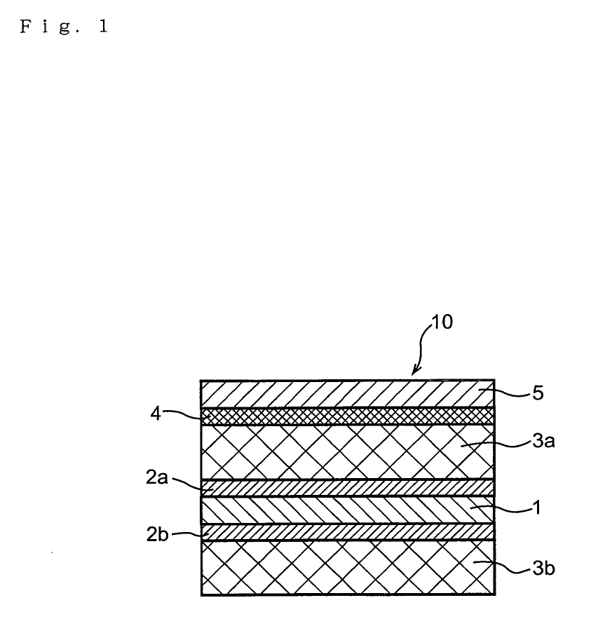

FIG. 1 is a cross-sectional view showing an embodiment of the multi-layer structure of the present invention. The multi-layer structure 10 includes an oxygen gas barrier layer 1; inorganic-nucleating-agent-containing resin composition layers 3a and 3b which are respectively provided, via adhesive resin layers 2a and 2b, on both surfaces of the layer 1; a peelability-imparting layer 4; and a surface layer 5, the layers 4 and 5 being successively laminated on the inorganic-nucleating-agent-containing resin composition layer 3a.

The container of the present invention can be formed by subjecting the multi-layer structure of the present invention to heat molding by means of, for example, vacuum forming, pressure forming, vacuum pressure forming, or press forming; or by subjecting any of the aforementioned resin compositions to a molding technique which is generally employed for thermoplastic resins, such as injection molding (e.g., injection blow molding) or extrusion molding (extrusion film/sheet molding or blow molding).

The container of the present invention is useful as a container for retort foods (e.g., cooked rice), a container for medical instruments, or a container for industrial precision components.

### EXAMPLES

The present invention will next be described in more detail by way of Examples, which should not be construed as limiting the invention thereto.

Physical properties of each of the structures formed in the below-described Examples were measured through the following methods.

<Specific Weight>

Specific weight was measured through the water replacement method according to JIS. K7112 by means of an automatic gravimeter (product of Toyo Seiki Seisaku-Sho, Ltd.).

<Elastic Modulus>

Storage modulus of a test piece was measured until the temperature of the test piece reached its melting temperature according to JIS K7198 by means of a solid viscoelasticity measuring apparatus [DMS6100, product of Seiko Instruments Inc.] with a 1-Hz stretching mode while temperature was raised from 10° C. to 23° C., 80° C., and 140° C. at 10° C./minute.

<Falling Dart Impact Strength>

Falling dart impact strength was measured according to JIS K6921 by means of HTM-1 (product of Shimadzu Corporation) with an impact dart of 13.7 mmφ at −5° C. and a falling rate of 1 m/s.

<Odor>

A sheet-like extruded product was cut into pieces, each having a size of about 20 mm×about 50 mm, and the pieces (total weight: 10 g) were placed into a 300-mL vial, followed by heating at 90° C. for 60 minutes. Thereafter, organoleptic test was performed by three panelists, and odor was evaluated on the basis of the criteria (six ratings) shown in Table 1.

<S value>

In a graph in which the Y-axis corresponds to −5° C. falling dart impact strength and the X-axis corresponds to 80° C. elastic modulus, the straight line formed by connecting two points corresponding to the data of Comparative Examples 13 and 14 is represented by the following formula 1.
Y=−0.0057X+4.317 (formula 1)

When a straight line is drawn from a point with coordinate (X: 80° C. elastic modulus, Y: −5° C. falling dart impact strength) corresponding to an arbitrary resin composition toward the straight line represented by formula 1 so that the two lines are orthogonalized, the distance between the crossing point and the point with coordinate (X, Y), which distance is defined as “S value,” is determined by the following formula 2.
S=(0.0057X+Y−4.317)/[(0.0057)²+1]^{1/2} (formula 2)

The impact resistance and elastic modulus of a polypropylene composition is in a trade-off relation; i.e., the greater the impact resistance, the lower the elastic modulus.

However, the composition of the present invention exhibits an unpredictable effect (high low-temperature impact resistance and high elastic modulus); i.e., the composition of the present invention exhibits a type of synergistic effect.

S value is a quantitative index representing the degree of deviation from the aforementioned trade-off relation.

Therefore, when a point with coordinate (X, Y) is present above the straight line represented by formula 1, and the distance between the point and the line increases, S value increases, and both impact resistance and elastic modulus are enhanced.

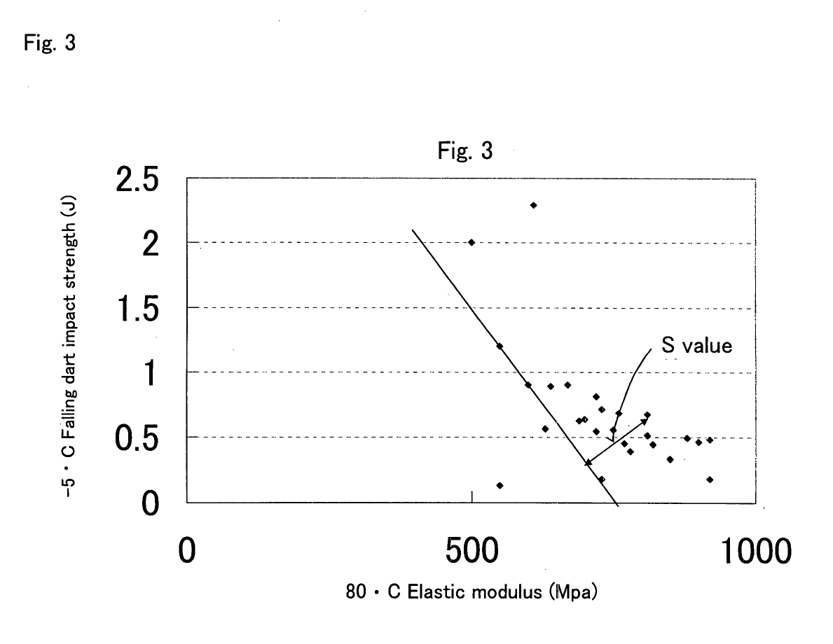

FIG. 3 schematically shows S values and the relation between −5° C. falling dart impact strength (Y-axis) and 80° C. elastic modulus (X-axis).

<Percent Reduction in Thickness>
Percent reduction in thickness (TRR)=(E/E₀)^{1/3}−1 (formula 3)

In the formula, E represents the elastic modulus of a resin composition, and E₀ represents the elastic modulus of standard polypropylene [i.e., 1,420 MPa (23° C.), see Comparative Example 13].

When percent reduction in thickness obtained by formula 3 is high, even if the thickness of a molded product is reduced, the entirety of the molded product is highly likely to maintain its rigidity.

<Percent Reduction in Weight>

When molded products have the same shape, the weight of each of the molded products is determined by the thickness of the molded product and the specific weight of the material constituting the product.

As described below, percent reduction in weight (WRR) can be calculated on the basis of the aforementioned percent reduction in thickness, and percent increase in specific weight with respect to a standard material.
WRR=TRR−(ρ−ρ₀)/ρ₀

In the formula, ρ represents the specific weight of a resin composition, and ρ₀ represents the specific weight of polypropylene (i.e., 0.900, see Comparative Example 13).

TABLE 1

| Odor rating | Odor strength |
|---|---|
| 0 | No odor |
| 1 | Slight odor |
| 2 | Weak odor at such a level that an odor source can |
| | be identified |
| 3 | Unpleasant odor |
| 4 | Strong odor |
| 5 | Very strong odor |

Physical properties of each of the structures formed in the below-described Examples were measured through the following methods.

<Peel Strength>

The surface layer of a cut sheet (30 mm×250 mm) was melt-adhered to a laminate film formed of PET (polyethylene terephtalate) (thickness: 12 μm)/PA66 (66 nylon) (thickness: 15 μm)/random PP (polypropylene) (thickness: 50 μm) by means of a heat sealing machine at 190° C. and 0.23 MPa for 1.2 seconds so that the bonding area was 10 mm×25 mm, and subsequently the resultant laminate was left to cool. The force required for peeling back the aforementioned laminate film at 180° was measured by means of a push-pull gauge.

<Pressure Resistance>

The aforementioned laminate film was provided as a lid member for a container, and the laminate film was melt-adhered to a flange portion (circumferential portion having a width of 4 mm) of the container at 190° C. and 0.98 MPa for 1.2 seconds. Subsequently, the thus-hermetically-sealed container was left to cool.

After the hermetically sealed container was immersed in a water bath heated to 80° C. for 30 minutes, a rubber seal (20 mm×20 mm) was attached to the lid member, and a syringe was inserted through the rubber-sealed portion. While the syringe was inserted, the container was evacuated by means of a vacuum pump, and the pressure at the time when the container was deformed was measured.

### Examples 1 to 4 and Comparative Examples 1 to 5

An extruded sheet (thickness: 700 μm) was formed from raw materials [PP: polypropylene, E/αR: ethylene-α-olefin copolymer rubber (elastomer), talc, HDPE1: high-density polyethylene] constituting a resin composition shown in Table 2 by means of a 30-φ uniaxial extruder.

Specifically, the extruded resin composition sheet was formed by feeding, to a hopper of the extruder, the aforementioned raw materials which had been dry-blended in advance in predetermined proportions, followed by extrusion molding.

Properties of the thus-formed sheet are shown in Table 2.

(Note)

1. B-PP: block polypropylene; density: 910 kg/m³, MFR: 0.5 g/10 minutes (230° C.), isotactic pentad fraction: 0.94 [“E-154G” (trade name), product of Idemitsu Petrochemical Co., Ltd.]
2. H-PP: highly stereoregular homopolypropylene; density: 910 kg/m³, MFR: 0.5 g/10 minutes (230° C.), isotactic pentad fraction: 0.97 [“Idemitsu Polypro E100GV” (trade name), product of Idemitsu Petrochemical Co., Ltd.]
3. HDPE1: high-density polyethylene; density: 956 kg/m³, MFR: 0.32 g/10 minutes (190° C.) [“Idemitsu Polyethy 548B” (trade name), product of Idemitsu Petrochemical Co., Ltd.]
4. EOR: ethylene-octene-l copolymer (octene-1 content: 25 mass %); density: 870 kg/m³, MFR: 5 g/10 minutes (190° C.) [“Engage 8200” (trade name), product of DuPont Dow]
5. Talc: mean particle size: 4.9 μm [“TP-A25F” (trade name), product of Fuji Talc Industrial Co., Ltd.]
   There was employed a masterbatch (talc content: 60 mass %) which had been prepared in advance.

R-PP: random polypropylene [“R720” (trade name), product of Idemitsu Petrochemical Co., Ltd.] was employed as a base of the masterbatch. Calcium. stearate (1.3 parts by mass) and a phenolic antioxidant [Irganox 1010, product of Ciba Specialty Chemicals] (0.3 parts by mass) were added to R-PP (100 parts by mass), and the resultant mixture was formed into masterbatch pellets by means of a biaxial kneader (HTM-38, product of CTE).

### Examples 5 to 8 and Comparative Examples 6 to 10

Raw materials [PP: polypropylene, E/αR: ethylene-α-olefin copolymer rubber (elastomer), talc, HDPE2: high-density polyethylene] constituting a resin (RC) composition shown in Table 3, an ethylene-vinyl alcohol copolymer (EVOH), and an adhesive resin (AD) were subjected to coextrusion, to thereby form a multi-layer structure including RC (320 μm)/AD (15 μm)/EVOH (30 μm)/AD (15 μm)/RC (320 μm).

Specifically, the thus-extruded resin composition structure was formed by feeding, to a hopper of an extruder, the raw materials which had been dry-blended in advance in predetermined proportions, followed by extrusion molding.

Properties of the thus-formed multi-layer structure are shown in Table 3.

(Note)

1. Adhesive resin (RD): maleic-anhydride-modified PP (polypropylene); density: 900 kg/m³, MFR: 2.8 g/10 minutes (190° C.) [Admer QF550, product of Mitsui Chemicals, Inc.]
2. EVOH: ethylene-vinyl alcohol copolymer; density: 1,180 kg/m³, MFR: 2.0 g/10 minutes (190° C.) [J102B, product of Kuraray Co., Ltd.]

### Examples 9 to 12

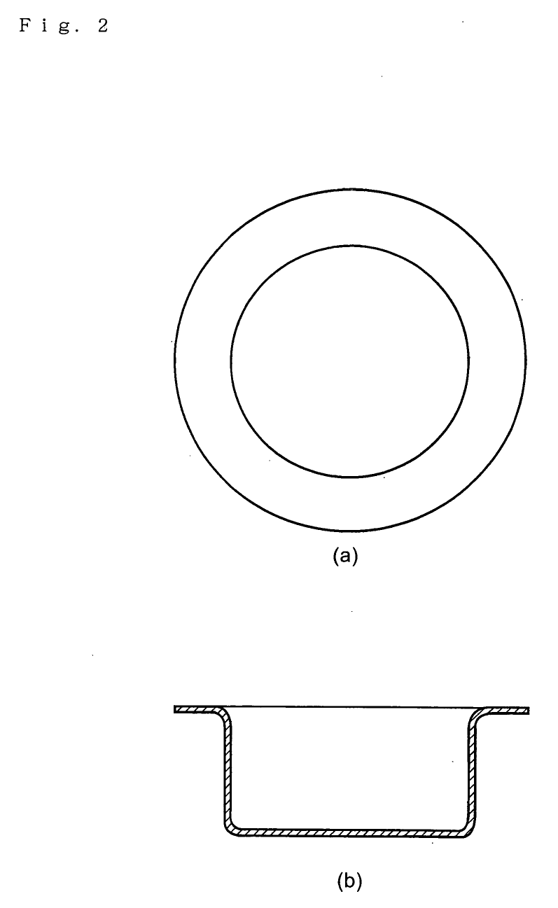

A peelability-imparting layer and a surface layer were successively provided, through coextrusion, on one surface of the multi-layer structure obtained in Example 6, to thereby form a multi-layer structure (see FIG. 1). The thus-formed structure was subjected to heat molding by means of vacuum pressure forming, to thereby form a container (inner diameter: 120 mm, depth: 40 mm) (see FIG. 2, the multi-layer structure is not illustrated).

In each of these Examples, the surface layer was formed of R-PP so as to attain a thickness of 80 μm.

Example 9: The peelability-imparting layer was formed of a HDPE2/LDPE (80/20 mass %) blend so as to attain a thickness of 10 μm.

Example 10: The peelability-imparting layer was formed of H-PP/LDPE (50/50 mass %) blend so as to attain a thickness of 20 μm.

Example 11: The peelability-imparting layer was formed of the same material as that employed in Example 9 so as to attain a thickness of 40 μm.

Example 12: The procedure of Example 9 was repeated, except that the multi-layer structure of Example 6 was replaced by the multi-layer structure of Example 8, to thereby form a container.

Physical properties of the thus-formed containers are shown in Table 4.

In Table 4, “peelability-imparting layer thickness ratio (%)” represents the ratio (percentage) of the thickness of the peelability-imparting layer to the total thickness of the multi-layer structure employed in the container.

### Comparative Examples 11 and 12

Comparative Example 11: The procedure of Example 9 was repeated, except that the thickness of the peelability-imparting layer was changed to 100 μm.

Comparative Example 12: The procedure of Example 11 was repeated, except that the thickness of the peelability-imparting layer was changed to 150 μm.

Physical properties of the thus-formed containers are shown in Table 4.

(Note)

1. HDPE2: high-density polyethylene; density: 951 kg/m³, MFR: 0.87 g/10 minutes [“Idemitsu Polyethy 440M” (trade name), product of Idemitsu Petrochemical Co., Ltd.]
2. LDPE: high-pressure low-density polyethylene; density: 920 kg/m³, MFR: 6.7 g/10 minutes (190° C.), Tm: 107° C. [“HE-30”, (trade name), product of Japan Polyethylene Corporation]

3. R-PP: random polypropylene; density: 910 kg/m³, MFR: 1.3 g/10 minutes (230° C.), melting point: 146° C. [“Idemitsu Polypro E233GV” (trade name), product of Idemitsu Petrochemical Co., Ltd.]

TABLE 2
Properties of resin composition and
single-layer structure

| Physical properties | |
|---|---|
| | −5° C. Falling |

| | | | |
|---|---|---|---|
| Resin composition (mass %) | Specific | Elastic Modulus (MPa) | dart impact |

| | PP | E/αR | Talc | weight | 23° C. | 80° C. | 140° C. | strength (J) | Odor |
|---|---|---|---|---|---|---|---|---|---|
| Ex. 1 | B-PP (98) | — | 2.0 | 0.94 | 1900 | 710 | 190 | 2.4 | 0 to 1 |
| Ex. 2 | H-PP (88) | EOR (10) | 2.0 | 0.93 | 2400 | 780 | 240 | 2.3 | 0 to 1 |
| Ex. 3 | H-PP (88) | EOR (10) | 2.0* | 0.93 | 2400 | 770 | 230 | 1.2 | 0 to 1 |
| Ex. 4 | H-PP (78)¹⁾ | EOR (10) | 2.0 | 0.94 | 2300 | 710 | 180 | 3.5 | 0 to 1 |
| Comp. | B-PP (100) | — | — | 0.91 | 1420 | 550 | 160 | 1.2 | 0 to 1 |
| Ex. 1 | | | | | | | | | |
| Comp. | H-PP (100) | — | — | 0.91 | 2200 | 750 | 230 | 0.35 | 0 to 1 |
| Ex. 2 | | | | | | | | | |
| Comp. | H-PP (98) | — | 2.0 | 0.94 | 2600 | 900 | 310 | 0.2 | 0 to 1 |
| Ex. 3 | | | | | | | | | |
| Comp. | B-PP (70) | EOR (10) | 20 | 1.17 | 2200 | 800 | 210 | 3.2 | 3 to 4 |
| Ex. 4 | | | | | | | | | |
| Comp. | H-PP (89.9) | EOR (10) | 0.1** | 0.90 | 2300 | 820 | 250 | 0.5 | 2 to 3 |
| Ex. 5 | | | | | | | | | |

¹⁾The remaining component: HDPE (10 mass %).
*The mean particle size of talc was changed to 18 μm.
**Talc was replaced by Adeka Stab M701 [phosphorus-containing organic nucleating agent] (5 mass % NA11 masterbatch). The numerical value represents NA11 content.

TABLE 3
Properties of resin composition and
multi-layer structure

| Multi-layer structure* | |
|---|---|
| | −5° C. Falling |

| | | | |
|---|---|---|---|
| Resin [RC] composition (mass%) | Specific | Elastic Modulus (MPa) | dart impact |

| | PP | E/αR | Talc | weight | 23° C. | 80° C. | 140° C. | strength (J) | Odor |
|---|---|---|---|---|---|---|---|---|---|
| Ex. 5 | B-PP (98) | — | 2.0 | 0.94 | 1820 | 680 | 180 | 2.3 | 1 |
| Ex. 6 | H-PP (88) | EOR (10) | 2.0 | 0.93 | 2270 | 750 | 240 | 2.3 | 1 |
| Ex. 7 | H-PP (88) | EOR (10) | 2.0** | 0.93 | 2270 | 740 | 230 | 1.2 | 1 |
| Ex. 8 | H-PP (78)¹⁾ | EOR (10) | 2.0 | 0.94 | 2140 | 680 | 180 | 3.4 | 1 |
| Comp. | B-PP (100) | — | — | 0.91 | 1530 | 500 | 130 | 2.4 | 1 |
| Ex. 6 | | | | | | | | | |
| Comp. | H-PP (100) | — | — | 0.91 | 2100 | 720 | 220 | 0.35 | 1 |
| Ex. 7 | | | | | | | | | |
| Comp. | H-PP (98) | — | 2.0 | 0.94 | 2500 | 860 | 300 | 0.2 | 1 |
| Ex. 8 | | | | | | | | | |
| Comp. | B-PP (70) | EOR (10) | 20 | 1.17 | 2100 | 760 | 200 | 3.2 | 3 to 4 |
| Ex. 9 | | | | | | | | | |
| Comp. | H-PP (89.9) | EOR (10) | 0.1*** | 0.90 | 2200 | 800 | 230 | 0.5 | 2 to 3 |
| Ex. 10 | | | | | | | | | |

¹⁾The remaining component: HDPE (10 mass %).
*RC (320 μm)/AD (15 μm)/EVOH (30 μm)/AD (15 μm)/RC (320 μm)
**The mean particle size of talc was changed to 13 μm.
***Talc was replaced by Adeka Stab M701 [phosphorus-containing organic nucleating agent] (5 mass % NA11 masterbatch). The numerical value represents NA11 content.

TABLE 4
Properties of container formed of multi-layer
structure having peelability

| | Peelability- | | |
|---|---|---|---|
| | imparting | | 80° C. |
| | layer thickness | Peel strength | Pressure resistance |
| | ratio (%) | (N/10 mm width) | (MPa) |
| Ex. 9 | 1.3 | 3.1 | 0.07 |
| Ex. 10 | 2.5 | 1.6 | 0.06 |
| Ex. 11 | 5.2 | 3.0 | 0.06 |
| Ex. 12 | 1.3 | 3.2 | 0.06 |
| Comp. Ex. 11 | 11.4 | 2.9 | 0.04 |
| Comp. Ex. 12 | 16.1 | 3.2 | 0.03 |

### Examples 13 to 23 and Comparative Examples 13 to 21

In a manner similar to that of Example 1, an extruded sheet (thickness: 700 μm) was formed from raw materials constituting a resin composition shown in Table 5 by means of a 30-φ uniaxial extruder.

In Table 5, the amount of talc is represented by parts by mass on the basis of 100 parts by mass of the total amount of the resin components.

Specifically, the extruded resin composition sheet was formed by feeding, to a hopper of the extruder, the aforementioned raw materials which had been dry-blended in advance in predetermined proportions, followed by extrusion molding.

Properties of the thus-formed sheet are shown in Table 5.

(Note)

1. H-PP1: highly sterebregular homopolypropylene; density: 910 kg/m³, MFR: 0.5 g/10 minutes (230° C.), isotactic pentad fraction: 0.97 [“Idemitsu Polypro E200GV” (trade name), product of Idemitsu Petrochemical Co., Ltd.]
2. H-PP2: highly stereoregular homopolypropylene; density: 910 kg/m³, MFR: 1.6 g/10 minutes (230° C.), isotactic pentad fraction: 0.97 [“Idemitsu Polypro E200GV” (trade name), product of Idemitsu Petrochemical Co., Ltd.]
3. H-PP3: highly stereoregular homopolypropylene; density: 910 kg/m³, MFR: 9.0 g/10 minutes (230° C.), isotactic pentad fraction: 0.97 [“Idemitsu Polypro Y900GV” (trade name), product of Idemitsu Petrochemical Co., Ltd.]
4. H-PP4: highly stereoregular homopolypropylene; density: 910 kg/m³, MFR: 18 g/10 minutes (230° C.) , isotactic pentad fraction: 0.97 [“Idemitsu Polypro Y2000GV” (trade name), product of Idemitsu Petrochemical Co., Ltd.]
5. EOR: ethylene-octene-1 copolymer (octene-1 content: 25 mass %); density: 870 kg/m³, MFR: 5 g/10 minutes (190° C.) [“Engage 8200” (trade name), product of DuPont Dow]
6. HDPE1: high-density polyethylene; density: 956 kg/m³, MFR: 0.32 g/10 minutes (190° C.) [“Idemitsu Polyethy 548B” (trade name), product of Idemitsu Petrochemical Co., Ltd.]
7. B-PP: block polypropylene; density: 910 kg/m³, MFR: 0.5 g/10 minutes (230° C.), isotactic pentad fraction: 0.94 [“E-154G” (trade name), product of Idemitsu Petrochemical Co., Ltd.]
8. LH-PP1: low-stereoregularity homopolypropylene; density: 910 kg/m3, MFR: 0.5 g/10 minutes (230° C.), isotactic pentad fraction: 0.93 [“Idemitsu Polypro E105GM” (trade name), product of Idemitsu Petrochemical Co., Ltd.]
9. Talc: mean particle size: 4.9 μm [“TP-A25F” (trade name), product of Fuji Talc Industrial Co., Ltd.]

There was employed a masterbatch (talc content: 60 mass %) which had been prepared in advance (i.e., the same masterbatch as employed in Examples 1 to 4).

TABLE 5
Properties of resin composition and single-layer structure

| | | | | |
|---|---|---|---|---|
| | −5° C. | | Percent | |
| Talc | Falling | Percent | increase | Percent |
| particle | dart | reduction | in | reduction |
| size μmφ | impact | in | specific | in |

| | | | | | | | | |
|---|---|---|---|---|---|---|---|---|
| Resin composition (mass %) | (parts by | strength | Elastic modulus (MPa) | S | thickness | Specific | weight | weight |

| | PP | E/αR | PE | mass) | (J) | 23° C. | 80° C. | 140° C. | value | (%) | weight | (%) | (%) |
|---|---|---|---|---|---|---|---|---|---|---|---|---|---|
| Ex. 13 | H-PP1 (95) | EOR (5) | — | 4.9 (0.50) | 0.54 | 1,960 | 720 | 250 | 0.3 | 11.3 | 0.913 | 1.5 | 7.9 |
| Ex. 14 | H-PP1 (95) | EOR (5) | — | 4.9 (1.00) | 0.55 | 1,950 | 750 | 260 | 0.5 | 11.2 | 0.918 | 2.0 | 8.9 |
| Ex. 15 | H-PP1 (95) | EOR (5) | — | 4.9 (2.00) | 0.45 | 2,030 | 770 | 260 | 0.5 | 12.7 | 0.928 | 3.2 | 8.7 |
| Ex. 16 | H-PP1 (98) | EOR (2) | — | 4.9 (2.00) | 0.33 | 2,160 | 850 | 290 | 0.9 | 15.0 | 0.930 | 3.3 | 12.3 |
| Ex. 17 | H-PP1 (96.5) | EOR (3.5) | — | 4.9 (2.00) | 0.39 | 1,920 | 780 | 280 | 0.5 | 10.6 | 0.929 | 3.2 | 9.1 |
| Ex. 18 | H-PP1 (93) | EOR (7) | — | 4.9 (2.00) | 0.71 | 1,980 | 730 | 250 | 0.6 | 11.7 | 0.928 | 3.1 | 6.8 |
| Ex. 19 | H-PP1 (90) | EOR (10) | — | 4.9 (2.00) | 0.90 | 1,800 | 670 | 230 | 0.4 | 8.2 | 0.926 | 2.9 | 3.9 |
| Ex. 20 | H-PP2 (95) | EOR (5) | — | 4.9 (2.00) | 0.44 | 2,070 | 820 | 280 | 0.8 | 13.4 | 0.928 | 3.2 | 11.1 |
| Ex. 21 | H-PP3 (95) | EOR (5) | — | 4.9 (2.00) | 0.46 | 2,230 | 900 | 310 | 1.3 | 16.2 | 0.928 | 3.2 | 14.7 |
| Ex. 22 | H-PP4 (95) | EOR (5) | — | 4.9 (2.00) | 0.49 | 2,250 | 880 | 310 | 1.2 | 16.6 | 0.928 | 3.2 | 13.8 |
| Ex. 23 | H-PP1 (85) | EOR (5) | HDPE1 (10) | 4.9 (2.00) | 0.81 | 1,960 | 720 | 200 | 0.6 | 11.3 | 0.933 | 3.7 | 5.7 |
| Comp. | B-PP (100) | — | | — | 1.2 | 1,420 | 550 | 160 | 0.0 | 0.0 | 0.900 | 0.0 | 0.0 |
| Ex. 13 | | | | | | | | | | | | | |
| Comp. | H-PP1 (100) | — | | — | 0.18 | 1,900 | 730 | 250 | 0.0 | 10.2 | 0.910 | 1.1 | 8.8 |
| Ex. 14 | | | | | | | | | | | | | |
| Comp. | H-PP1 (95) | EOR (5) | | — | 0.54 | 1,775 | 685 | 230 | 0.1 | 7.7 | 0.908 | 0.9 | 6.7 |
| Ex. 15 | | | | | | | | | | | | | |
| Comp. | H-PP1 (100) | — | | 4.9 (2.00) | 0.18 | 2,450 | 920 | 320 | 1.1 | 19.9 | 0.930 | 3.4 | 15.3 |
| Ex. 16 | | | | | | | | | | | | | |
| Comp. | LH-PP1 (95) | EOR (5) | | 4.9 (2.00) | 0.56 | 1,770 | 630 | 190 | −0.2 | 7.6 | 0.928 | 3.2 | 1.5 |
| Ex. 17 | | | | | | | | | | | | | |
| Comp. | H-PP1 (95) | EOR (5) | | 4.9 (0.10) | 0.62 | 1,810 | 690 | 230 | 0.2 | 8.4 | 0.909 | 1.0 | 6.8 |
| Ex. 18 | | | | | | | | | | | | | |
| Comp. | H-PP1 (95) | EOR (5) | | 4.9 (0.25) | 0.63 | 1,830 | 700 | 240 | 0.3 | 8.8 | 0.911 | 1.2 | 7.2 |
| Ex. 19 | | | | | | | | | | | | | |
| Comp. | | | | | | | | | | | | | |
| Ex. 20 | H-PP1 (95) | EOR (5) | | 4.9 (4.00) | 0.55 | 2,040 | 750 | 280 | 0.5 | 12.8 | 0.948 | 5.3 | 5.5 |
| Comp. | | | | | | | | | | | | | |
| Ex. 21 | H-PP1 (80) | EOR (20) | | 4.9 (2.00) | 2.0 | 1,440 | 500 | 170 | 0.5 | 0.5 | 0.923 | 2.5 | −5.6 |

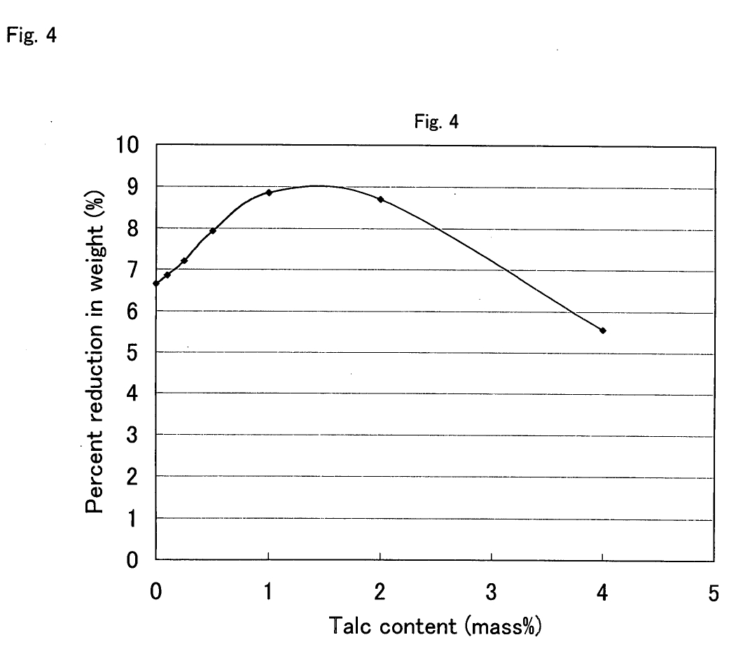

FIG. 4 shows the effect of contained talc (mean particle size: 4.9 μm) on the percent reduction in weight of a molded product (see Examples 13 to 15 and Comparative Examples 18 to 20 in Table 5).

### Examples 24 to 29 and Comparative Examples 22 to 25

In a manner similar to that of Example 1, an extruded sheet (thickness: 700 μm) was formed from raw materials constituting a resin composition shown in Table 6 by means of a 30-φ uniaxial extruder.

In Table 6, the amount of talc is represented by parts by mass on the basis of 100 parts by mass of the total amount of the resin components.

Specifically, the extruded resin composition sheet was formed by feeding, to a hopper of the extruder, the aforementioned raw materials which had been dry-blended in advance in predetermined proportions.

Properties of the thus-formed sheet are shown in Table 6.

(Note)

1. H-PP1: highly stereoregular homopolypropylene; density: 910 kg/m³, MFR: 0.5 g/10 minutes (230° C.), isotactic pentad fraction: 0.97 [“Idemitsu Polypro E200GV” (trade name), product of Idemitsu Petrochemical Co., Ltd.]
2. EOR1: ethylene-octene-l copolymer; density: 857 kg/m³, MFR: 5 g/10 minutes (190° C.) [“Engage 8842” (trade name), product of DuPont Dow]
3. EOR2: ethylene-octene-1 copolymer; density: 870 kg/m³, MFR: 5 g/10 minutes (190° C.) [“Engage 8200” (trade name), product of DuPont Dow]
4. EOR3: ethylene-octene-1 copolymer; density: 885 kg/m³, MFR: 5 g/10 minutes (190° C.) [“Engage 8003” (trade name), product of DuPont Dow]
5. EOR4: ethylene-octene-1 copolymer; density: 902 kg/m³, MFR: 5 g/10 minutes (190° C.) [“Engage 8450” (trade name), product of DuPont Dow]
6. EOR5: ethylene-octene-1 copolymer; density: 910 kg/m3, MFR: 5 g/10 minutes (190° C.) [“Engage 8445” (trade name), product of DuPont Dow]
7. EBR1: ethylene-butene-1 copolymer; density: 870 kg/m³, MFR: 5.0 g/10 minutes (190° C.) [“ENR 7447” (trade name), product of DuPont Dow]
8. Talc: mean particle size: 4.9 μm [“TP-A25F” (trade name), product of Fuji Talc Industrial Co., Ltd.]

There was employed a masterbatch (talc content: 60 mass %) which had been prepared in advance (i.e., the same masterbatch as employed in Examples 1 to 4).
9. Talc: mean particle size: 1.0 μm [“SG-2000” (trade name), product of Nippon Talc Co., Ltd.]

There was employed a masterbatch (talc content: 20 mass %) which had been prepared in advance from the same base and additive formulation as employed in Examples 1 to 4.

TABLE 6
Properties of resin composition and single-layer structure

| | | | | |
|---|---|---|---|---|
| | −5° C. | | Percent | |
| Talc | Falling | Percent | increase | Percent |
| particle | dart | reduction | in | reduction |
| size μmφ | impact | in | specific | in |

| | | | | | | | | |
|---|---|---|---|---|---|---|---|---|
| Resin composition (mass %) | (parts by | strength | Elastic modulus (MPa) | S | thickness | Specific | weight | weight |

| | PP | E/αR | mass) | (J) | 23° C. | 80° C. | 140° C. | value | (%) | weight | (%) | (%) |
|---|---|---|---|---|---|---|---|---|---|---|---|---|
| Ex. 24 | H-PP1 (90) | EOR1 (10) | 4.9 (2.0) | 1.07 | 1,680 | 640 | 220 | 0.4 | 5.8 | 0.925 | 1.7 | 3.5 |
| Ex. 25 | H-PP1 (90) | EOR2 (10) | 4.9 (2.0) | 0.58 | 1,920 | 730 | 240 | 0.4 | 10.6 | 0.926 | 1.8 | 8.1 |
| Ex. 26 | H-PP1 (90) | EOR3 (10) | 4.9 (2.0) | 0.72 | 1,950 | 710 | 240 | 0.4 | 11.2 | 0.928 | 2.0 | 6.9 |
| Ex. 27 | H-PP1 (95) | EBR1 (5) | 1.0 (0.50) | 0.52 | 2,140 | 800 | 270 | 0.8 | 14.7 | 0.913 | 0.3 | 14.3 |
| Ex. 28 | H-PP1 (95) | EBR1 (5) | 1.0 (1.00) | 0.51 | 2,030 | 770 | 260 | 0.6 | 12.7 | 0.918 | 0.9 | 11.8 |
| Ex. 29 | H-PP1 (95) | EBR1 (5) | 1.0 (2.00) | 0.74 | 2,100 | 810 | 270 | 1.0 | 13.9 | 0.928 | 2.0 | 11.9 |
| Comp. | H-PP1 (90) | EOR4 (10) | 4.9 (2.0) | 0.43 | 2,110 | 750 | 240 | 0.4 | 14.1 | 0.930 | 2.2 | 8.7 |
| Ex. 22 | | | | | | | | | | | | |
| Comp. | H-PP1 (90) | EOR5 (10) | 4.9 (2.0) | 0.32 | 2,100 | 750 | 240 | 0.3 | 13.9 | 0.930 | 2.2 | 8.7 |
| Ex. 23 | | | | | | | | | | | | |
| Comp. | H-PP1 (95) | EBR1 (5) | 1.0 (4.0) | 0.57 | 2,070 | 830 | 290 | 1.0 | 13.4 | 0.948 | 4.2 | 9.2 |
| Ex. 24 | | | | | | | | | | | | |
| Comp. | H-PP1 (95) | EBR1 (5) | 1.0 (8.0) | 0.57 | 2,290 | 910 | 320 | 1.4 | 17.3 | 0.985 | 8.2 | 9.0 |
| Ex. 25 | | | | | | | | | | | | |
| Comp. | H-PP1 (95) | EBR1 (5) | 1.0 (0.25) | 0.49 | 1,980 | 740 | 250 | 0.39 | 11.7 | 0.910 | 0.0 | 11.7 |
| Ex. 26 | | | | | | | | | | | | |

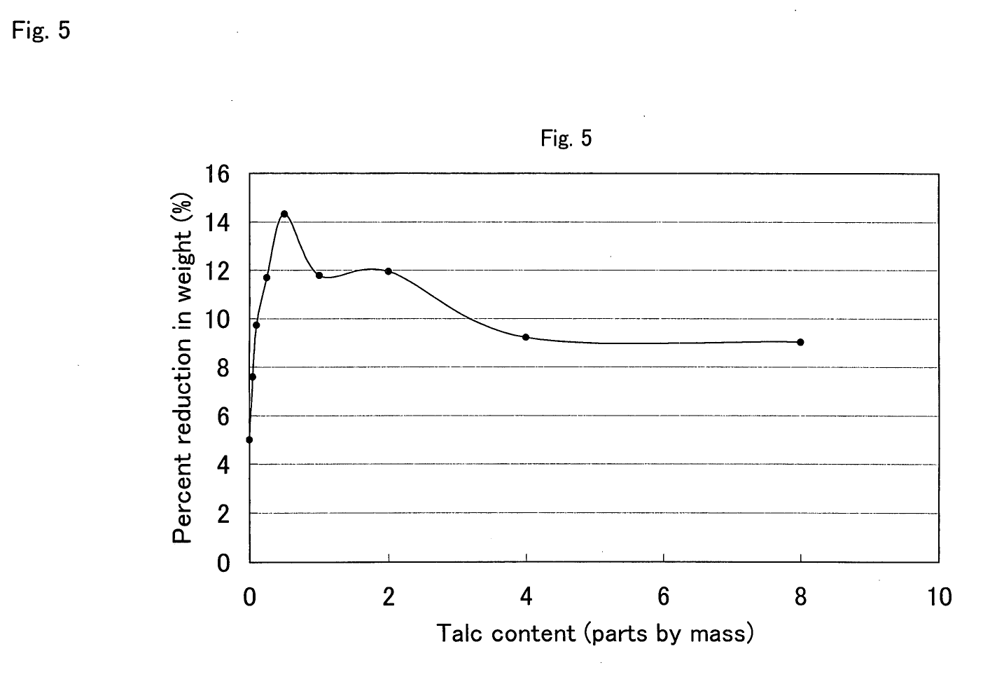

FIG. 5 shows the effect of contained talc (mean particle size: 1.0 μm) on the percent reduction in weight of a molded product (see Examples 27 to 29 and Comparative Examples 24 to 26 in Table 6).

### INDUSTRIAL APPLICABILITY

The present invention provides an inorganic-nucleating-agent-containing resin composition, which exhibits high elastic modulus within a high-temperature range of room temperature or higher, which exhibits excellent impact resistance within a low-temperature range of the freezing point or lower, which emits odor at such a low level that it can be employed for food products, and which minimizes an increase in specific weight. When a multi-layer structure is formed from the composition, the thickness of the structure can be reduced, and thus the weight thereof can be decreased. In addition, when a container, an injection-molded product, or an extrusion-molded product is produced from the composition through heat molding, production cost can be reduced.

1. An inorganic-nucleating-agent-containing resin composition (A) characterized by comprising a combination of a component (a) a propylene homopolymer or propylene block copolymer having a propylene-chain isotactic pentad fraction of 0.90 or more; a component (b) an ethylene-α-olefin copolymer rubber, in an amount of 0.5 to 15 mass % when the component (a) is a propylene homopolymer, or in an amount of 0 to 10 mass % when the component (a) is a propylene block copolymer; a component (c) a high-density polyethylene, in an amount of 0 to 20 mass %; and a component (d) an inorganic nucleating agent, in an amount of 0.4 to 3.0 parts by mass on the basis of 100 parts by mass of the total amount of the components (a), (b), and (c).

2. An inorganic-nucleating-agent-containing resin composition (A) as described in claim 1, wherein the propylene homopolymer or propylene block copolymer has a propylene-chain isotactic pentad fraction of 0.95 or more.

3. An inorganic-nucleating-agent-containing resin composition (A) as described in claim 1 or 2, wherein, when the component (a) is a propylene homopolymer, the amount of the ethylene-α-olefin copolymer rubber is 0.5 to 10 mass %.

4. An inorganic-nucleating-agent-containing resin composition (A) as described in any of claim 1 to 3, wherein the ethylene-α-olefin copolymer rubber includes an α-olefin unit having 4 to 12 carbon atoms.

5. An inorganic-nucleating-agent-containing resin composition (A) as described in any of claims 1 to 4, wherein the ethylene-α-olefin copolymer rubber has a density of 840 to 900 kg/m³.

6. An inorganic-nucleating-agent-containing resin composition (A) as described in any of claims 1 to 5, wherein the high-density polyethylene has a density of 935 kg/m³ or more, and the amount of the high-density polyethylene is 1 to 20 mass % with respect to the total amount of the components (a) and (b).

7. An inorganic-nucleating-agent-containing resin composition (A) as described in any of claims 1 to 6, wherein the inorganic nucleating agent is talc.

8. A multi-layer structure having a total thickness of 200 μm or more, characterized in that at least one layer constituting the multi-layer structure is formed of an inorganic-nucleating-agent-containing resin composition (A) as recited in any of claims 1 to 7, and the thickness of the resin composition layer accounts for 50% or more of the total thickness of the multi-layer structure.

9. A multi-layer structure having a total thickness of 200 μm or more, characterized in that at least one layer constituting the multi-layer structure is formed of an inorganic-nucleating-agent-containing resin composition (A) as recited in any of claims 1 to 7; the thickness of the resin composition layer accounts for 50% or more of the total thickness of the multi-layer structure; the multi-layer structure further comprises a surface layer formed of a propylene resin or propylene resin composition (B), and a peelability-imparting layer which is adjacent to the surface layer, which is formed of a resin composition or resin (C) containing a combination of a propylene resin in an amount of less than 80 mass % and a thermoplastic resin other than a propylene resin in an amount of 20 mass % or more, and which has a thickness 0.1 to 10% of the total thickness of the multi-layer structure; and a surface layer portion of the multi-layer structure, which portion includes the surface layer, has a peel strength of at least 1.0 to 10 N/10 mm width.

10. A container produced through heat molding of a multi-layer structure as recited in claim 8 or 9.

11. A container as described in claim 10, which is a food container.

12. An extrusion-molded product formed of an inorganic-nucleating-agent-containing resin composition (A) as recited in any of claims 1 to 7.

13. An injection-molded product formed of an inorganic-nucleating-agent-containing resin composition (A) as recited in any of claims 1 to 7.

14. A method for producing a molded product of an inorganic-nucleating-agent-containing resin composition (A) as recited in any of claims 1 to 7 above, comprising preparing a masterbatch containing a polyolefin resin as a base, and a component (d) at a high concentration; subsequently dry-blending the masterbatch with remaining components other than the component (d); and producing a molded product employing the dry-blended product as a raw material.

15. A method for producing a molded product as described in claim 14, wherein the molded product is a multi-layer structure.

16. A method for producing a molded product as described in claim 14, wherein the molded product is a container.

17. A method for producing a molded product as described in claim 14, wherein the molded product is an extrusion-molded product.

18. A method for producing a molded product as described in claim 14, wherein the molded product is an injection-molded product.
